(19) United States
(12) Patent Application Publication
(10) Pub. No.: US 2012/0151233 A1
(43) Pub. Date: Jun. 14, 2012

(54) NETWORK DEVICE FOR CONTROLLING POWER CONSUMPTION AND METHOD EMPLOYING THE SAME

(75) Inventor: KUAN-HSIANG CHAO, Tu-Cheng (TW)

(73) Assignee: HON HAI PRECISION INDUSTRY CO., LTD., Tu-Cheng (TW)

(21) Appl. No.: 13/052,130

(22) Filed: Mar. 21, 2011

(30) Foreign Application Priority Data
Dec. 14, 2010 (TW) 99143841

(51) Int. Cl. G06F 1/32; G06F 1/26

(52) U.S. Cl. 713/322; 713/300

(57) ABSTRACT

A network device for controlling power consumption includes a power supply unit, a central processing unit (CPU) and a power consumption control unit. The power supply unit provides electrical energy to the network device. The power consumption control unit includes a baseband management controller (BMC) and a north bridge. The BMC presets a predetermined power, the north bridge detects output power of the power supply unit, the BMC compares the output power with the predetermined power of the network device, and controls the north bridge to adjust operating frequency of the CPU according to the comparison until the output power of the power supply unit equals the predetermined power of the network device.

### BACKGROUND

1. Technical Field

The disclosure generally relates to network device behavior control, and more particularly to a network device and a method thereof for automatically controlling power consumption of the network device.

2. Description of the Related Art

When network devices, such as computers, repeaters, modems, servers and routers, work at their rated power, they can work normally and consume power. Thus, power consumption measurement is required for the network devices to adjust their operating power and save energy. However, most network devices cannot automatically control and regulate the operating power to their rated power according to the power consumption, which may result in energy waste and fail to meet requirements of the users.

Therefore, there is room for improvement within the art.

### BRIEF DESCRIPTION OF THE DRAWINGS

Many aspects of an exemplary network device for controlling power consumption and method employing the same can be better understood with reference to the following drawings. The components in the drawings are not necessarily drawn to scale, the emphasis instead being placed upon clearly illustrating the principles of the exemplary network device for controlling power consumption and method employing the same. Moreover, in the drawings, like reference numerals designate corresponding parts throughout the several views. Wherever possible, the same reference numbers are used throughout the drawings to refer to the same or like elements of an embodiment.

FIG. 1 is a block diagram of a network device for controlling power consumption, according to an exemplary embodiment of the disclosure.

FIGS. 2A-2B are flowcharts illustrating a method for controlling power consumption of the network device, according to an exemplary embodiment of the disclosure.

### DETAILED DESCRIPTION

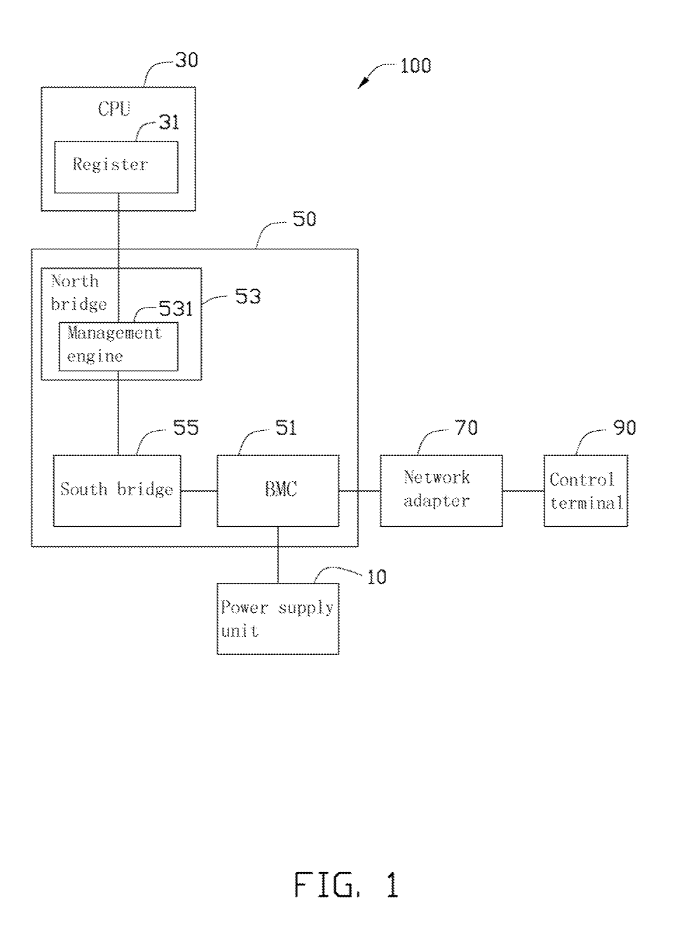

FIG. 1 shows a block diagram of a network device 100 for controlling power consumption, according to an exemplary embodiment of the disclosure. The network device 100 can be a computer, a server, a repeater, or a router, and the computer is used here as an example to illustrate the network device 100.

The network device 100 includes a power supply unit (PSU) 10, a central processing unit (CPU) 30, and a power consumption control unit 50. The power consumption control unit 50 is electrically connected to the PSU 10 and the CPU 30. The PSU 10 can be a direct current (DC) power source (e.g., a battery) to directly provide electrical energy to the network device 100. The PSU 10 can further be a power adapter, which is electrically connected to an alternating current (AC) power source, and the PSU 10 converts the AC to corresponding voltage to power the network device 100.

The CPU 30 controls the network device 100, and carries out different instructions in sequence, to perform the basic arithmetical, input/output, and logical operations of the network device 100. When the operating frequencies of the CPU 30 change, the power consumptions of the heating radiators, the memories, and other electronic components in the network device 100 will change accordingly. Thus, the power consumption of the network device 100 is adjusted by regulating operating frequency of the CPU 30.

The CPU 30 includes a register 31, which may be a status register and can store various status information and control information of the network device 100. The register 31 includes a plurality of advanced configuration and power management interfaces (ACPIs) and defines a plurality of frequency states, where each frequency state corresponds to an operating frequency of the CPU 30. Thus, the operating freqencies of the CPU 30 and the power consumptions of the network device 100 can be dynamically adjusted by controlling and by regulating the frequency states of the CPU 30, accordingly.

In this exemplary embodiment, the register 31 defines sixteen frequency states: P1, P2, P3 . . . Pn−1 and Pn, where n is a positive integer and 1<=n<=16. In detail, for example, when the register 31 is adjusted to enter frequency state P1, the CPU 30 works at a maximum power and a maximum operating frequency, corresponding to a maximum power consumption of the network device 100. When the register 31 enters frequency state P2, the CPU 30 will work at a secondary operating frequency and power, which corresponds to a secondary power consumption of the network device 100.

The power consumption control unit 50 includes a baseband management controller (BMC) 51 and a north bridge 53 electrically connected to the BMC 51. The BMC 51 is electrically connected to the PSU 10 for detecting output power of the PSU 10. The BMC 51 presets and defines a maximum predetermined power of the network device 100, and controls the north bridge 53 to adjust the operating frequency of the CPU 30 according to the output power of the PSU 10 and the maximum predetermined power of the network device 100.

The BMC 51 detects and receives different operating parameters of the network device 100, such as temperature, cooling fan speeds, power status, and operating system, and monitors the operating patameters to send alerts to the CPU 30 if any of the parameters fail to stay within preset limits, indicating a potential failure of the network device 100. In this exemplary embodiment, the BMC 51 obtains the output power of the PSU 10, and determines whether the output power exceeds the maximum predetermined power of the network device 100 or not. If the output power from the PSU 10 exceeds the predetermined power of the network device 100, the BMC 51 accordingly controls the north bridge 53 to lower the operating frequency of the CPU 30 until the output power equals to the predermined power of the network device 100. This results in reduction of power consumption of the network device 100 and the output power of the PSU 10. If the output power of the PSU 10 is lower than the predetermined power, the BMC 51 accordingly controls the north bridge 53 to increase the operating frequency of the CPU 30 until the output power equals to the predetermined power of the network device 100, resulting in increase of the power consumption of the network 100 and output power of the PSU 10.

The north bridge 53 accesses the CPU 30 to read a maximum frequency state Pn and a current frequency state Pc of the CPU 30, and the transmits the maximum frequency state Pn and the current frequency state Pc to the BMC 51. The BMC 51 compares the output power of the PSU 10 with the predetermined power of the network device 100 to determine whether the output power exceeds the predetermined power according to the maximum frequency state Pn and the current frequency state Pc. In this exemplary embodiment, the north bridge 53 includes a management engine unit 531 electrically connected to the BMC 51 and the CPU 30. The management engine unit 531 is capable of adjusting and selecting the frequency state to accordingly regulate the operating power of the CPU 30 under the control of the BMC 51.

In this exemplary embodiment, the power consumption control unit 50 further includes a south bridge 55. The CPU 30, the north bridge 53, the south bridge 55 and the BMC 51 are electrically connected in series. The south bridge 55 is capable of receiving and transmitting different data than the north bridge 53 and the BMC 51.

The network device 100 further includes a network adapter 70 which allows the network device 100 to communicate over a control terminal 90 (e.g., a host). Thus, the control terminal 90 can remotely control and regulate the frequency state of the CPU 30 and the predetermined power the network device 100 to dynamically adjust the power consumption of the network device 100 in real time.

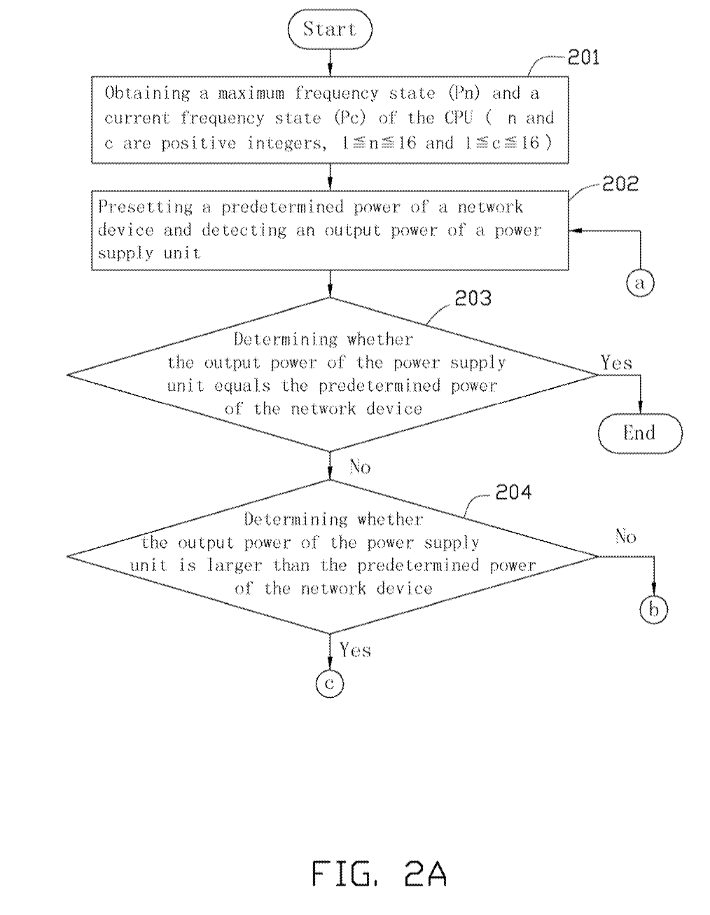

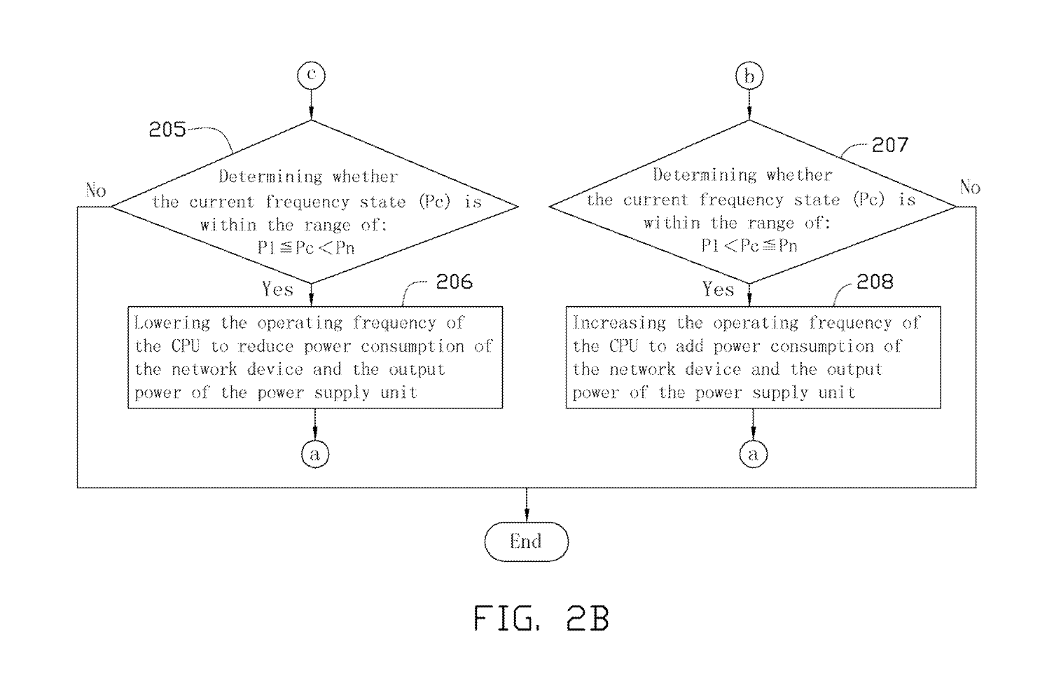

Also referring to FIGS. 2a and 2b, a control method for power consumption according to an exemplary embodiment of the disclosure is depicted. The method can use the aforementioned network device 100 to detect and control the power consumption, and may include at least the following steps.

In step S201, the management engine unit 531 of the north bridge 53 accesses the CPU 30 to read and obtain a maximum frequency state Pn and a current frequency state Pc of the CPU 30, where n and c are positive integers, 1<=n<=16 and 1<=c<=16, and transmits the maximum frequency state Pn and the current frequency state Pc to the BMC 51.

In step S202, the BMC 51 presets a predetermined power of the network device 100, and detects an output power of the PSU 10. In this exemplary embodiment, the control terminal 90 can be used to remotely preset the predetermined power of the network device 100.

In step S203, the BMC 51 determines whether the output power of the PSU 10 is equal to the predetermined power of the network device 100 or not. If the output power of the PSU 10 equals the predetermined power of the network device 100, then go to the end; if the output power of the PSU 10 is unequal to the predetermined power of the network device 100, then go to step S204.

In step S204, the BMC 51 determines whether the output power of the PSU 10 is larger than the predetermined power of the network device 100 or not. If the output power of the PSU 10 is larger than the predetermined power of the network device 100, then go to step S205; if the output power of the PSU 10 is less than the predetermined power of the network device 100, then go to step S207.

In step S205, the BMC 51 determines whether the current frequency state Pc of the CPU 30 is in the range of: P1<=Pc<Pn, where P1 represents the first frequency state, and Pn represents the maximum frequency state. If the current frequency state Pc of the CPU 30 is within the range of: P1<=Pc<Pn, then go to step S206; if the current frequency state Pc of the CPU 30 is without the range of: P1<=Pc<Pn, then go to the end.

In step S206, the management engine unit 531 regulates the CPU 30 to lower the operating frequency of the CPU 30, resulting in reduction of the power consumption of the network device 100 and the output power of the PSU 10, and then repeat step S202.

In step S207, the BMC 51 determines whether the current frequency state Pc of the CPU 30 is in the range of: P1<Pc<=Pn. If the current frequency state Pc of the CPU 30 is within the range of: P1<Pc<=Pn, then go to step S208; if the current frequency state Pc of the CPU 30 is without the range of: P1<Pc<=Pn, then go to the end.

In step S208, the management engine unit 531 regulates the CPU to increase the operating frequency of the CPU 30, resulting in addition of the power consumption of the network device 100 and the output power of the PSU 10, and then repeat step S202.

In the network device 100 for controlling power consumption of the disclosure, power consumption control unit 50 can automatically adjust the operating frequency of the CPU 30, to accordingly regulate the power consumption of the network device 100, enabling the network device 100 to work at its predetermined frequency. Additionally, the operating frequency of the CPU 30 can be remotely regulated and can be preset by network adapter 70 in real time, which can save energy and meet needs of the users.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A network device, comprising:
a power supply unit that provides electrical energy to the network device;
a central processing unit (CPU); and
a power consumption control unit that electrically connects the power supply unit to the CPU, the power consumption control unit comprising:
a baseband management controller (BMC) that electrically connects the power supply unit to the CPU, the BMC for presetting a predetermined power of the network device; and
a north bridge that electrically connects the CPU to the BMC, wherein the north bridge detects output power of the power supply unit, the BMC compares the output power with the predetermined power of the network device, and the BMC controls the north bridge to adjust operating frequency of the CPU according to the comparison until the output power of the power supply unit equals the predetermined power of the network device.

2. The network device as claimed in claim 1, wherein the power supply unit is a direct current power source to directly provide electrical energy to the network device.

3. The network device as claimed in claim 1, wherein the power supply unit is a power adapter electrically connected to an alternating current power source, the power supply unit converts the alternating current into corresponding voltage to power the network device.

4. The network device as claimed in claim 1, wherein when operating frequency of the CPU changes, the power consumption of the network device is adjusted by adjusting the operating frequency of the CPU.

5. The network device as claimed in claim 1, wherein the CPU comprises a status register electrically connected to the north bridge, the register comprises a plurality of frequency states, each frequency state corresponding to an operating frequency of the CPU, the operating frequency of the CPU and the power consumption of the network device are adjusted by controlling and regulating the frequency states of the CPU.

6. The network device as claimed in claim 5, wherein when the register is adjusted to enter a first frequency state, the CPU works at a maximum power and a maximum operating frequency, corresponding to a maximum power consumption of the network device; when the register enters a second frequency state, the CPU works at a secondary operating frequency and power, corresponding to a secondary power consumption of the network device.

7. The network device as claimed in claim 5, wherein the BMC obtains the output power of the power supply unit, and determines whether the output power exceeds the predetermined power of the network device or not, if the output power from the power supply unit exceeds the predetermined power of the network device, the BMC controls the north bridge to lower the operating frequency of the CPU until the output power equals to the predetermined power of the network device, resulting in reduction of power consumption of the network device and the output power of the power supply unit.

8. The network device as claimed in claim 1, wherein if the output power of the power supply unit is lower than the predetermined power, the BMC accordingly controls the north bridge to increase the operating frequency of the CPU until the output power equals to the predetermined power of the network device, resulting in increase of the power consumption of the network and output power of the power supply unit.

9. The network device as claimed in claim 5, wherein the north bridge comprises a management engine unit electrically connected to the BMC and the CPU, and the management engine unit is capable of adjusting and selecting the frequency state of the CPU to regulate the operating power of the CPU under the control of the BMC.

10. The network device as claimed in claim 1, wherein the power consumption control unit further includes a south bridge, the CPU, the north bridge, the south bridge and the BMC are electrically connected in series, and the south bridge is capable of transmitting and receiving different data with the north bridge and the BMC.

11. The network device as claimed in claim 1, further comprising a network adapter allowing the network device to communicate over a control terminal, wherein the control terminal is capable of remotely controlling and regulating the frequency state of the CPU and the predetermined power the network device to adjust the power consumption of the network device in real time.

12. A method for controlling power consumption of a network device, the method comprising:
providing a network device, the network device comprising a power supply unit, a central processing unit (CPU) and a power consumption control unit, the power consumption control unit comprising a north bridge and a baseband management controller (BMC), and the CPU defining a plurality of frequency states;
obtaining a maximum frequency state (Pn) and a current frequency state (Pc) of the CPU by the north bridge (where n and c are positive integers, 1<=n<=16 and 1<=c<=16);
presetting a predetermined power of the network device and detecting output power of the power supply unit by the BMC; and
comparing the output power of the power supply unit with the predetermined power of the network device by the BMC to adjust operating frequency of the CPU until the output power of the power supply unit equals the predetermined power of the network device.

13. The method for controlling power consumption of a network device as claimed in claim 12, further comprising determining whether the output power of the power supply unit is larger than the predetermined power of the network device when the output power of the power supply unit is unequal to the predetermined power of the network device.

14. The method for controlling power consumption of a network device as claimed in claim 13, further comprising determining whether the current frequency state of the CPU in the range between a first frequency state (P1) and a maximum frequency state (P1<=Pc<Pn) when the output power of the power supply unit is larger than the predetermined power of the network device.

15. The method for controlling power consumption of a network device as claimed in claim 14, further comprising lowering the operating frequency of the CPU to reduce the power consumption of the network device and the output power of the power supply unit when the current frequency state (Pc) is within the range of: P1<=Pc<Pn.

16. The method for controlling power consumption of a network device as claimed in claim 14, further comprising determining whether the current frequency state of the CPU is in the range of P1<Pc<=Pn, when the output power of the power supply unit is less than the predetermined power of the network device.

17. The method for controlling power consumption of a network device as claimed in claim 16, further comprising increasing the operating frequency of the CPU to add the power consumption of the network device and the output power of the power supply unit when the current frequency state of the CPU is within the range of: P1<Pc<=Pn.
